(19) United States
(12) Patent Application Publication
(10) Pub. No.: US 2020/0320395 A1
(43) Pub. Date: Oct. 8, 2020

(54) METHODS AND DEVICES FOR OPTIMIZING MACHINE LEARNING MODEL COMPACTNESS AND ACCURACY THROUGH HARDWARE LATENCY HYSTERESIS EFFECT

(71) Applicant: ALIBABA GROUP HOLDING LIMITED, George Town, KY (US)

(72) Inventors: Hongxu YIN, San Mateo, CA (US); Weifeng ZHANG, San Mateo, CA (US); Guoyang CHEN, San Mateo, CA (US)

(21) Appl. No.: 16/374,738

(22) Filed: Apr. 3, 2019

(51) Int. Cl. G06N 3/08; G06N 3/04

(52) U.S. Cl. CPC G06N 3/082; G06N 3/0445; G06N 3/084

(57) ABSTRACT

A method for training a machine learning model, including acquiring an initial machine learning model, updating features of the initial machine learning model, updating dimension of the initial machine learning model based on the updated features of the initial machine learning model and one or more latency hysteresis points obtained based on a hardware profile of an accelerator configured to perform machine learning operations, and generating a final machine learning model based on the updated dimensions.

### TECHNICAL FIELD

The present disclosure relates to the technical field of machine learning and, more particularly, to methods and devices for optimizing machine learning model compactness and accuracy through hardware latency hysteresis effect.

### BACKGROUND

With the development of machine learning programs, the dimensions of machine learning models have been increased significantly to improve model accuracy. A large machine learning model, however, consumes substantial storage, memory bandwidth, and computational resources during model training or inference. These problems are exacerbated for mobile and embedded devices where the increasingly stringent latency constraints in real-time applications make large high-latency machine learning models unusable. Accordingly, these types of devices suffer from inaccuracies and inefficiencies when executing the large machine learning models.

### SUMMARY

The embodiments of the present disclosure provides a method that includes acquiring an initial machine learning model, updating features of the initial machine learning model, updating dimension of the initial machine learning model based on the updated features of the initial machine learning model and one or more latency hysteresis points obtained based on a hardware profile of an accelerator configured to perform machine learning operations, and generating a final machine learning model based on the updated dimensions.

Consistent with some embodiments, the present disclosure provides another method that includes acquiring, at a device, a trained machine learning model based on a hardware profile of the device, wherein the trained machine learning model, includes dimensions updated based on one or more latency hysteresis points obtained based on the hardware profile and executing, at the device, the trained machine learning model. Consistent with some embodiments, the present disclosure also provides a system for training a machine learning model. The system includes a memory structure comprising one or more gates configured to train a machine learning model using a hardware profile of an accelerator configured to perform machine learning operations, wherein the hardware profile is used to obtain one or more latency hysteresis points, wherein the training of the machine learning model comprises acquisition of an initial machine learning model, updating of features of the initial machine learning model, updating of dimensions of the initial machine learning model based on the updated features of the machine learning model and the one or more latency hysteresis points, and generation of a final machine learning model based on the updated dimensions.

Consistent with some embodiments, the present disclosure also provides a device. The device includes a memory configured to store a set of instructions and an accelerator configured to execute the set of instructions to cause the device to acquire, at the device, a trained machine learning model based on a hardware profile of the device, wherein the trained machine learning model includes dimensions updated based on one or more latency hysteresis points obtained based on the hardware profile and execute, at the device, the trained machine learning model.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate embodiments consistent with the invention and, together with the description, explain the principles of the invention.

FIG. 1 illustrates a block diagram of an exemplary accelerator system, consistent with some embodiments of the disclosure.

FIG. 2 illustrates an example of an LSTM (Long Short-Term Memory) cell architecture, consistent with some embodiments of the disclosure.

FIG. 3 illustrates a block diagram of an exemplary LSTM (Long Short-Term Memory) system, consistent with some embodiments of the disclosure.

FIGS. 4A-4B are exemplary graphs illustrating the latency hysteresis effect.

FIGS. 5A-5F are diagrams of exemplary machine learning models, consistent with some embodiments of this disclosure.

FIG. 6 is a flowchart of another exemplary method for optimizing machine learning model compactness and accuracy through hardware latency hysteresis effect, consistent with some embodiments of this disclosure.

FIG. 7 is a flowchart of another exemplary method for optimizing machine learning model compactness and accuracy through hardware latency hysteresis effect, consistent with some embodiments of this disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

In conventional systems with machine learning programs the dimensions of machine learning models have been increased significantly to improve model accuracy. A large machine learning model, however, consumes substantial storage, memory bandwidth, and computational resources, making it necessary to balance the model compactness, accuracy, and executing efficiency.

Embodiments of the present disclosure are directed to methods and devices for optimizing machine learning model compactness and accuracy through hardware latency hysteresis effect. For example, the embodiments of the present disclosure use observations of non-monotonic behavior called latency hysteresis effect that is introduced by hardware. By leveraging the hardware-impacted latency hysteresis effect, the embodiments of the present disclosure can achieve the symbiosis of model compactness and accuracy with execution efficiency, thus reducing the model latency while increasing its accuracy.

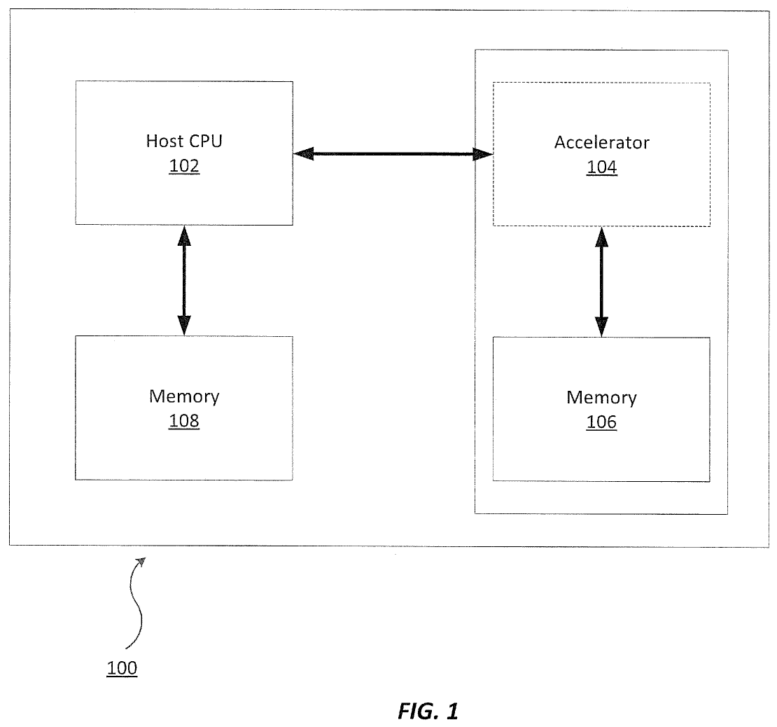

FIG. 1 illustrates a block diagram of an exemplary deep learning accelerator system 100, according to embodiments of the disclosure. Deep learning accelerator system 100 may include an accelerator 104, an accelerator memory 106, a host CPU 102, a host memory 108 associated with host CPU 102.

As illustrated in FIG. 1, accelerator 104 may be connected to host CPU 102 through a peripheral interface. As referred to herein, accelerator 104 may be a computing device for accelerating neural network computing tasks (e.g., such as an neural network processing unit (NPU), a graphic processing unit (GPU), field programmable gate arrays (FPGA), a Tensor processing unit (TPU), etc.). In some embodiments, accelerator 104 can include one or more Long Short-Term Memory (LSTM) cells, which is further described below. Accelerator 104 may be configured to be used as a co-processor (e.g. co-processor 308) of host CPU 102. Each of the host CPU 102 and accelerator 104 can be associated with its own memory device (e.g., memory 108 and 106). In some embodiments, accelerator 104 can be implemented by a heterogeneous acceleration chip where processing units do not have equal processing performance with each other.

In some embodiments, accelerator 104 may comprise a compiler (not shown). The compiler may be a program or a computer software that transforms computer code written in one programming language into accelerator instructions to create an executable program. In machine learning applications, a compiler may perform a variety of operations, for example, pre-processing, lexical analysis, parsing, semantic analysis, conversion of input programs to an intermediate representation, code optimization, code generation, or combinations thereof.

In some embodiments, the compiler may be on a host unit (e.g., host CPU 102 or host memory 108 of FIG. 1), configured to push one or more commands to accelerator 104.

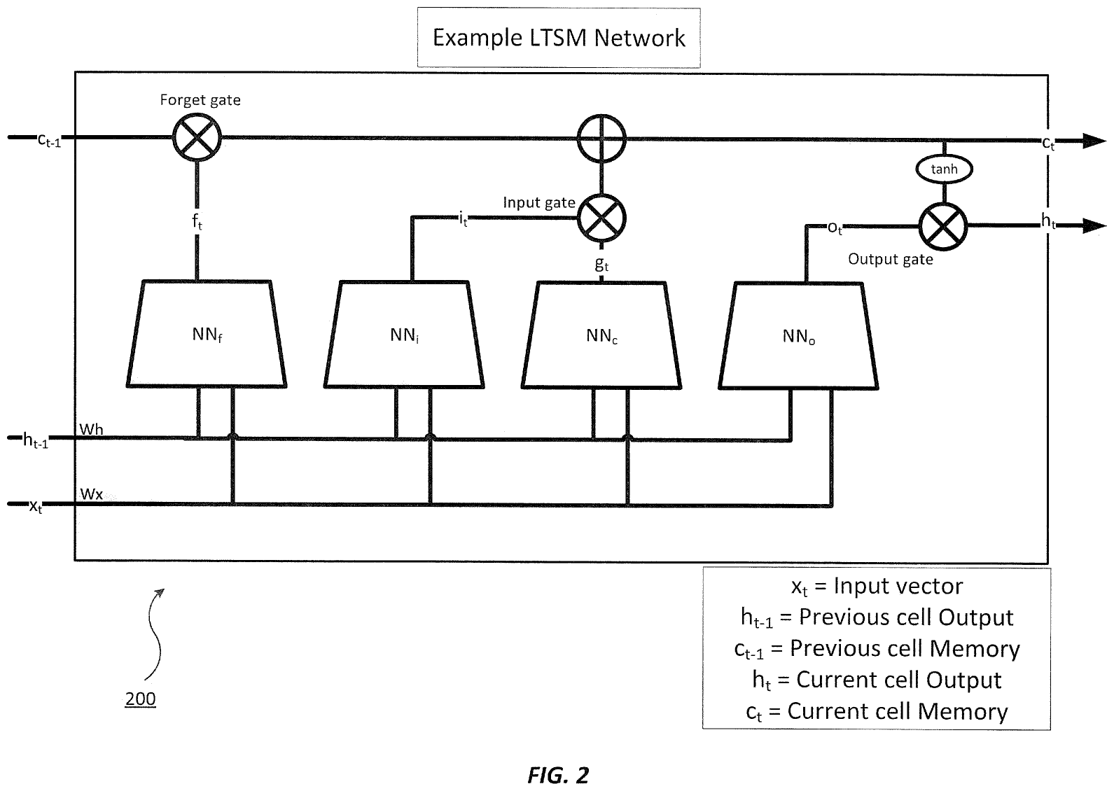

Based on these commands, a task manager may assign any number of tasks to one or more processing elements. Some of the commands may instruct a DMA unit of accelerator (e.g., DMA unit 306 of FIG. 2) to load instructions and data from host memory (e.g., memory 108 or off-chip memory 302 of FIG. 2) into a global memory. The loaded instructions may then be distributed to each processing element assigned with the corresponding task, and the one or more processing elements may process these instructions.

FIG. 2 illustrates an example of an LSTM cell architecture. LSTM has an RNN (Recurrent Neural Network) architecture and is designed to address a vanishing gradient problem. As shown in FIG. 2, the LSTM cell's state is split in two vectors hₜ and cₜ. Vector hₜ represents a short-term state, while vector cₜ. represents a long-term state. As the long-term state vector cₜ₋₁ traverses the cell from left to right, cₜ₋₁ first goes through a forget gate, dropping some memories, and then adds some new memories (further explained below) via an addition operation adding the memories selected by an input gate. The result cₜ is sent straight out without further transformation. Thereby, at each time step, some memories are dropped and some memories are added. After the addition operation, the long-term state vector cₜ is also copied and passed through a tanh function, and then the result is filtered by an output gate. This produces the short-term state vector hₜ, which is the cell's output for this time step.

The creation of new memories involves several steps. First, a previous short-term state vector hₜ₋₁ and a current input vector xₜ are fed to four different layers—forget layer NN_{f}, candidate layer NN_{c}, input layer NNᵢ, and output layer NNₒ—each of which serves a different purpose. The candidate layer NN_{c} outputs gₜ and has the role of analyzing a weighted current input vector xₜ and a weighted previous short-term state vector hₜ₋₁. In an LSTM cell, the output of layer NN_{c} does not go straight out, but instead it is partially stored in the long-term state cₜ.

The three other layers provide outputs to gate controllers (forget gate, input gate, and output gate). They use logistic activation functions (e.g., sigmoid function), and thus their outputs range from 0 to 1. As shown in FIG. 2, the three layers' outputs are fed to element-wise multiplication operations, so if they output Os, they close the gates, and if they output 1s, they open the gates. Specifically, the forget gate, which is controlled by fₜ, controls which parts of the long-term state should be erased. The input gate, which is controlled by iₜ, controls which parts of gₜ should be added to the long-term state cₜ. The output gate, which is controlled by oₜ, controls which parts of the long-term state cₜ should be read and output at this time step as hₜ and yₜ.

To achieve maximum training performance, weight matrices Wₕ and Wₓ are multiplied to the inputs hₜ₋₁ and xₜ. Here, the weight matrices Wₕ and Wₓ can be different for each of the different gates. For example, weight matrix W_{h-f} corresponding to the short-term state vector of the forget gate can be different from weight matrices Wₕ₋ᵢ and Wₕ₋ₒ corresponding to the short-tern state vector of input and output gates. Moreover, weight matrix W_{x-f} corresponding to the input vector of the forget gate can be different from weight matrices Wₓ₋ᵢ and Wₓ₋ₒ corresponding to the input vector of input and output gates.

At each gate, the inputs hₜ₋₁ and xₜ and their corresponding weight matrices Wₕ and Wₓ are multiplied. The result should be split into four which are fed into the sigmoid functions and hyperbolic tangent function (represented as four activation functions NN_{f}, NNᵢ, NN_{c}, NNₒ, respectively) to perform forget gate computing, output computing, input gate computing, and output gate computing.

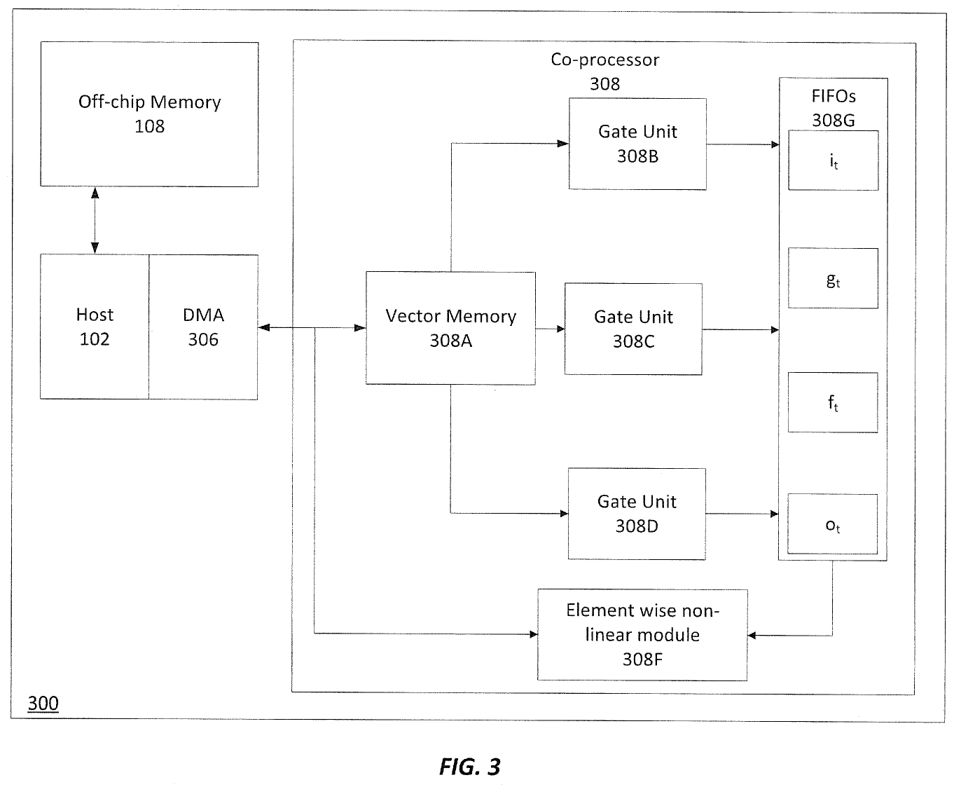

It is appreciated that the embodiment shown in FIG. 2 can be considered a schematic of a LSTM cell. The LSTM cell can be implemented as shown in FIG. 3, which illustrates a block diagram of an exemplary accelerator system 300, according to embodiments of the disclosure. Deep learning accelerator system 300 may include off-chip memory 108, host CPU 102, DMA unit 306, and an accelerator providing LSTM implementation 308. Accelerator 308 may include vector memory 308A, gate units 308B, 308C, and 308D, element wise non-linear module 308F, and first-input, first-output buffers (hereinafter “FIFOs”) 308G.

In some embodiments, a gated recurrent unit (GRU) may be used instead of a LSTM cell. The GRU may also be implemented as shown in FIG. 3.

In the implementation shown in FIG. 3, each gate and corresponding functions (hyperbolic tangent and logistic sigmoid) can be implemented into separate gate units 308B, 308C, and 308D. For example, gate unit 308B can correspond to an input gate and provide corresponding functionality, gate unit 308C can correspond to a forget gate and provide corresponding functionality, and gate unit 308D can correspond to an output gate and provide corresponding functionality. In some embodiments, a single gate unit (having multiple replicated gate units) or gate grid can be used in combination with a weight memory.

Each of the gate units 308B, 308C, and 308D can include at least two multiply accumulate (MAC) units that compute Wₕ hₜ₋₁ and Wₓ xₜ in parallel. The results from the MAC units are added together and the result is provided to an element wise non-linear module 308F, which may be implemented with piece-wise linear segmentation and can determine a long-term state vector and a short-term state vector.

The input vectors can be stored in a vector memory (VM) 308A until an LSTM layer is finished and new vectors come in. The intermediate results from gate units 308B, 308C, and 308D are locally stored in one or more different FIFO buffers 308G. The final vector results are computed by the element wise non-linear module 308F that receives the data from the FIFO buffers 308G and the cₜ₋₁ vector from DMA 306. The long-term state vector and a short-term state output vectors cₜ and hₜ can go back to memory 108 through a DMA unit 306.

In embodiments involving a gate grid, the gate grid includes a matrix of MAC units, where each MAC unit can process a different row of a weight matrix. The MAC unit can include multiple MACs that are single instruction multiple data (SIMD). The gate grid receives data from VM and WM, which can provide data in blocks of a size of number of MACs in a row.

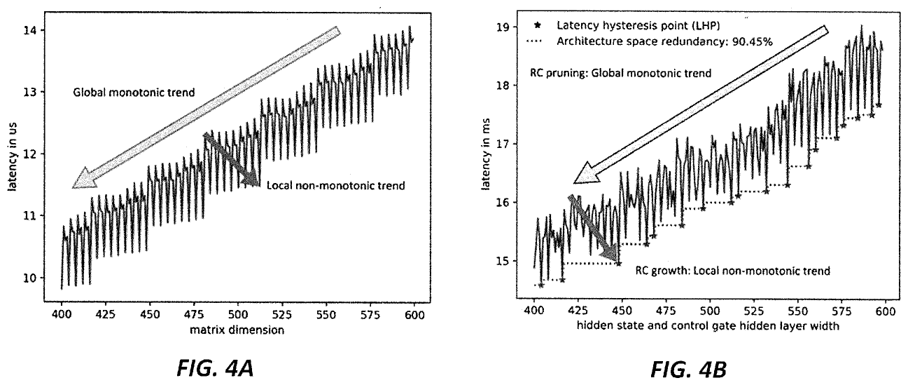

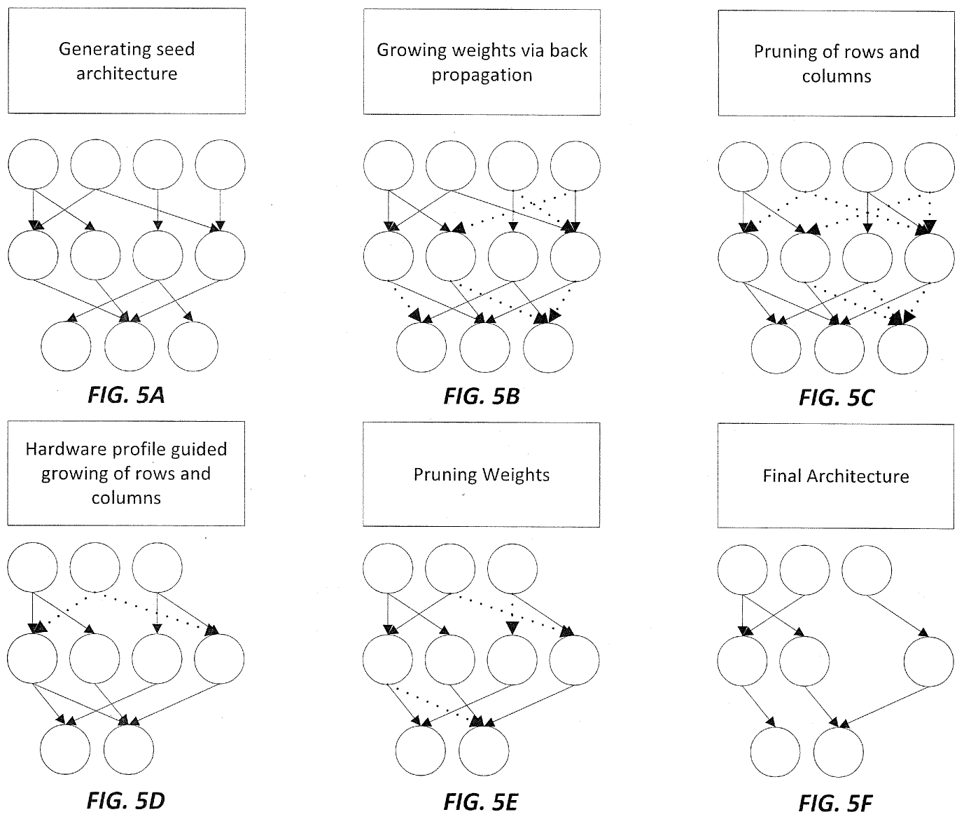

Device 100 may use a training flow for each of the gates. For example, the host CPU 102 may generate a seed architecture, such as the seed architecture having four input nodes and three output nodes shown in FIG. 5A. Using the LSTM and the results generated therefrom, host CPU 102 may then update the features of the machine learning model, such as by growing the weights via back propagation, as shown in FIG. 5B. Host CPU 102 may then use a pruning algorithm to update the dimensions of the machine learning model such as by pruning the rows and columns, as shown in FIG. 5C. Host CPU 102 may then use a determined latency hysteresis point, shown in FIG. 4B, and may again update the dimensions of the machine learning model such as by growing the rows and columns, as shown in FIG. 5D. Host CPU 102 may then update the features of the machine learning model again, such as by pruning the weights a final time, as shown i1 FIG. 5E. Afterwards, there is a final architecture for each NN gate, such as the one shown in FIG. 5F.

In some embodiments, updating the features of the machine learning model may be interpreted as pruning and growing the weights of the machine learning model. Therefore, pruning and/or growing the weights of a machine learning model may be interpreted as updating the features of the machine learning model. Additionally, updating the dimensions of the machine learning model may be interpreted as pruning and growing the rows and columns of the machine learning model such that the dimensions of the machine learning model are updated. Therefore, pruning and/or growing the rows and/or columns of a machine learning model may be interpreted as updating the dimensions of the machine learning model.

FIG. 4A is an exemplary graph illustrating the local non-monotonic trend and the global monotonic trend that make up the latency hysteresis effect. For example, the latency hysteresis effect is caused by cache line granularity when loading/storing data and vectorization optimization (e.g., vectorized vs. general matrix multiplication kernels) enabled at some particular data input dimensions to take full advantage of the bus bandwidth and single-instruction-multiple data (SIMD) nature of hardware processing units of an accelerator. This graph shows the model inference latency profile at the operation level. FIG. 4A represents, for example, the latency of the matrix multiplication operation, which has the highest computational importance. The matrix multiplication operation consumes more than half of the computational times for LTSMs. As shown in FIG. 4A, there is a global monotonic trend indicating that the smaller matrix dimensions are, in general, faster in terms of run-time latency, due to the reduced number of weights which result in less computation.

As shown in FIG. 4A, there is also a local non-monotonic trend that runs against the global monotonic trend. The local non-monotonic trend indicates that the run-time latency lags behind or even reverts the trend as the weight dimension decreases. Therefore, within the range of this local non-monotonic trend, smaller matrix dimension may actually be slower in terms of run-time latency. This local trend is referred to as the Latency Hysteresis Effect and the point where the Latency Hysteresis Effect begins to occur is referred to as the Latency Hysteresis Point. Within the latency hysteresis bin (i.e. the range of the local non-monotonic trend), smaller dimensions worsen run-time latency relative to the corresponding Latency Hysteresis Point.

FIG. 4B is an exemplary graph illustrating the global monotonic trend and the Latency Hysteresis Points (denoted by red stars). This graph shows the model inference latency profile at the inference model level. FIG. 4B represents, for example, the inference latency versus model size (specified by the hidden state width and the control gate hidden layer width) of the matrix multiplication operation, which has the highest computational importance. As shown in FIG. 4B, a smaller architecture, which is typically associated with a lower accuracy, may also have a slower run-time. This indicates the flaws in the traditional smaller-is-better strategy, given the existence of a large number of Latency Hysteresis Points that make more than 90% of the design points in FIG. 4B sub-optimal. The existence of these Latency Hysteresis Points, can therefore be exploited to achieve not only a faster run-time, but also a more accurate model.

FIGS. 5A-5F are diagrams of exemplary machine learning models, consistent with some embodiments of this disclosure. Each of FIGS. 5A-5F shows a different training step to learn the values, connectivity, and dimensions of each of the NN gates in an LSTM, such as the one in FIG. 3. The device for optimizing machine learning model compactness and accuracy through hardware latency hysteresis effect 100 may execute each of these training steps on the NN gates in the LSTM.

As shown in FIG. 5A, the training starts by the device for optimizing machine learning model compactness and accuracy 100 generating a sparse seed architecture that contains a small fraction of connections in order to facilitate the initial back propagation of gradient information shown in FIG. 5B.

As shown in FIG. 5B, the device for optimizing machine learning model compactness and accuracy grows weights via the back propagation of gradient information. This phase is referred to as the weight growth phase and the device for optimizing machine learning model compactness and accuracy 100 iteratively wakes up only the most effective connections to reach high accuracy based on the gradient information. Because the weight matrices Wₕ, and Wₓ can be different for each of the different gates, the gradient information may also be different for each of the different gates and different weights may be grown for different gates.

As shown FIG. 5C, the device for optimizing machine learning model compactness and accuracy 100 prunes the rows and columns to create a network dimension that corresponds with a lower latency. For example, the device for optimizing machine learning model compactness and accuracy may shrink the network dimensions, leading to lower inference latency, following the global monotonic trend identified in FIG. 4A.

As shown in FIG. 5D, the device for optimizing machine learning model compactness and accuracy 100 uses the latency hysteresis points, such as the latency hysteresis points shown in FIG. 4B, grow the rows and columns to create a network dimension that retains its low latency, or even further lowers the latency, while also attaining a higher accuracy. For example, the device for optimizing machine learning model compactness and accuracy may grow the network dimensions to a latency hysteresis point, such as one of the latency hysteresis points shown in FIG. 4B, leading to lower inference latency and higher accuracy, following the local non-monotonic trend identified in FIG. 4A.

In some embodiments, the training steps shown in FIGS. 5C-5D are repeated more many iterations until the model reaches a desirable size, based on the accuracy and latency.

As shown in FIG. 5E, the device for optimizing machine learning model compactness and accuracy, may then prune away some weights for extra compactness. Because the latency hysteresis points are already known, this pruning is stopped if there are corresponding latency problems. By pruning weights, the size of the model is reduced which leads to a smaller storage size. Since we have already optimized both latency and accuracy, this allows for a model that optimizes latency, accuracy, and compactness.

The final architecture, as shown in FIG. 5F is used for the NN gates. This final architecture is fully optimized for the desired variables since latency and accuracy were optimized in FIGS. 5C and 5D and compactness was optimized in FIG. 5E.

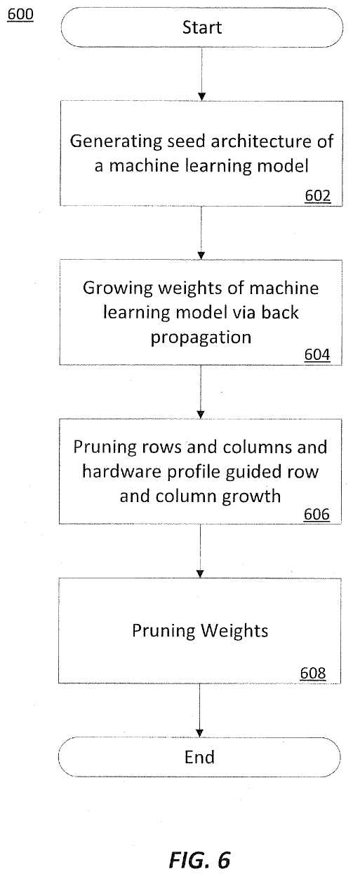

FIG. 6 is a flowchart of an exemplary method 600 for optimizing machine learning model compactness and accuracy though hardware latency hysteresis effect, consistent with some embodiments of this disclosure. The exemplary method 600 may be performed by a processor (e.g., host CPU 102) of a device, such as a smart phone, a tablet, a Personal Computer (PC), or the like.

In step 602, the processor generates a seed architecture of a machine learning model. For example, the processor may generate a randomly initialized sparse seed architecture of a machine learning model. The remaining connections in the machine learning model are all masked to zero (i.e., dormant), allowing all neurons in the network to be connected while still facilitating the initial back-propagation of gradient information performed in the next step.

In step 604, the processor grows the weights of the machine learning model via back propagation. For example, the processor may use the seed architecture generated in step 602 and iteratively wake up only the most effective dormant connections. To determine which dormant connections are most effective, the processor uses backpropagation (i.e. backwards propagation of errors) to obtain a loss function and corresponding gradient for the model.

In step 606, the processor prunes the rows and columns and then grows the rows and columns based on the hardware profile of the device running the machine learning program.

For example, the processor may prune away redundant connections to improve compactness and latency.

Afterwards, by the processor obtains the hardware profile of the device running the machine learning program and thereby obtains the latency hysteresis points corresponding with the hardware profile (e.g. the latency hysteresis points shown in FIG. 4B). For example, the processor may determine the hardware profile of the device running the machine learning program and obtain, from the hardware profile, the latency hysteresis points of the device. The processor may then use those latency hysteresis points to grow the rows and columns until the model reaches an optimal design point corresponding with one of the latency hysteresis points.

In some embodiments, because the processor grows the rows and columns of the machine learning model based on the hardware profile, the processor is able to create an architecture of the machine learning model that optimizes both accuracy and latency to avoid sub-optimal design points, such as the 90.45% of sub-optimal design points shown in FIG. 4B (labeled architecture space redundancy).

In step 608, the processor prunes additional weights to cut down the storage size of the model and thereby improves compactness. Because the latency hysteresis points were obtained in step 606, the processor will stop pruning if doing so produces latency problems.

In some embodiments, the processor may not perform step 608 if the model obtained in step 606 is already at the optimal size, based on the latency and accuracy.

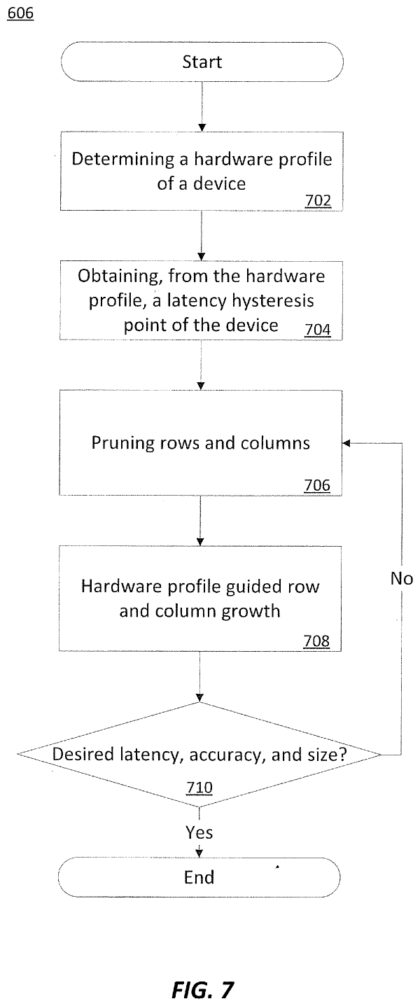

FIG. 7 is a flowchart of an exemplary method 606 for optimizing machine learning model compactness and accuracy though hardware latency hysteresis effect, consistent with some embodiments of this disclosure. The exemplary method 606 corresponds with step 606 from FIG. 7 and may be performed by a processor (e.g., host CPU 102) of a device, such as a smart phone, a tablet, a Personal Computer (PC), or the like.

In step 702, the processor determines a hardware profile of a device (e.g. a CPU or a GPU) running a machine learning program. For example, the processor may analyze the device to determine a model inference latency profile, such as the graphs shown in FIGS. 4A-4B.

In some embodiments, the hardware profile of the device may already be known if the hardware profile for the device has already been determined.

In step 704, the processor obtains, from the hardware profile, one or more latency hysteresis points of the device. For example, the processor may analyze the model inference latency profile determined in step 702. The processor may then identify the local non-monotonic trends, such as the one shown in FIG. 4A and obtain one or more latency hysteresis points, such as the ones shown in FIG. 4B.

In step 706, the processor prunes the rows and columns of the machine learning model. For example, the processor may take the model from step 604 of method 600 and prune the model to reduce the size of the model and improve the latency according to the global monotonic trend, such as the one shown in FIG. 4A.

In step 708, the processor grows the rows and columns of the machine learning model based on the one or more latency hysteresis points. For example, the processor may take the model from step 706 and grow the model to increase accuracy and further decrease latency according to the local non-monotonic trend, such as the one shown in FIG. 4A.

In step 710, the processor determines whether the model has reached the desired latency, accuracy, and size. For example, the processor may have a desired size stored in memory (e.g. memory 106). If the model is larger than the desired size, steps 706 and 708 may be repeated until the model reaches the desired size. Likewise, if the model is smaller than the desired size, steps 706 and 708 may be repeated until the model reaches the desired size. If it is determined that the model has reached the desired size, the processor continues to step 608 of method 600.

In some embodiments, the machine learning model is retrained after the row and column pruning and row and column growing to recover performance before the next iteration. In this case, the pruning and growing phase may terminate when retraining the machine learning model cannot achieve a pre-defined accuracy or latency threshold.

In some embodiments, the processor may have a desired latency and/or accuracy threshold stored in memory. If the model has a higher latency or a lower accuracy than desired, steps 706 and 708 are repeated until the model reaches the desired latency and accuracy. If it is determined that the model has reached the desired latency and accuracy, the processor continues to step 608 of method 600.

In some embodiments, methods 600 and 606 may not be performed at the processor of the device (e.g., host CPU 102). For example, methods 600 and 606 may be performed on a cloud server separate from the device having an accelerator, such as accelerator 104 of FIG. 1. The device having an accelerator, therefore, may acquire the machine learning model trained according to methods 600 or 606 and then execute the trained machine learning model based on the training described above.

In some embodiments, a non-transitory computer-readable storage medium including instructions is also provided, and the instructions may be executed by a device (such as a terminal, a personal computer, or the like), for performing the above-described methods.

Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

One of ordinary skill in the art will understand that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This disclosure is intended to cover any variations, uses, or adaptations of the disclosed embodiments following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

1. A method for training a machine learning model, the method comprising:
acquiring an initial machine learning model,
updating features of the initial machine learning model,
updating dimensions of the initial machine learning model based on the updated features of the initial machine learning model and one or more latency hysteresis points obtained based on a hardware profile of an accelerator configured to perform machine learning operations; and
generating a final machine learning model based on the updated dimensions.

2. The method of claim 1, wherein updating the features of the initial machine learning model further comprises:
growing weights in the initial machine learning model using back propagation; and
pruning weights of the initial machine learning model.

3. The method of claim 1, wherein updating dimensions of the initial machine learning model based on the updated features of the initial machine learning model and one or more latency hysteresis points comprises:
growing a row or a column of the initial machine learning model based on the one or more latency hysteresis points.

4. The method of claim 1, wherein updating dimensions of the initial machine learning model based on the updated features of the initial machine learning model and one or more latency hysteresis points comprises:
pruning a row or a column of the initial machine learning model based on the one or more latency hysteresis points.

5. The method of claim 1, wherein the hardware profile of the accelerator comprises a model inference latency profile of the accelerator.

6. The method of claim 1, wherein acquiring the initial machine learning model of the machine learning program uses a long-short term memory structure.

7. A method comprising:
acquiring, at a device, a trained machine learning model based on a hardware profile of the device, wherein the trained machine learning model includes dimensions updated based on one or more latency hysteresis points obtained based on the hardware profile; and
executing, at the device, the trained machine learning model.

8. The method of claim 7, wherein the dimensions of the trained machine learning model updated based on one or more latency hysteresis point comprises dimensions updated by growing a row or a column of the machine learning model based on the one or more latency hysteresis points.

9. The method of claim 7, wherein the dimensions of the trained machine learning model updated based on one or more latency hysteresis point comprises dimensions updated by pruning a row or a column of the machine learning model based on the one or more latency hysteresis points.

10. The method of claim 7, wherein the hardware profile of the device comprises a model inference latency profile of one or more accelerators of the device.

11. A system for training a machine learning model comprising:
a memory structure comprising one or more gates configured to train a machine learning model using a hardware profile of an accelerator configured to perform machine learning operations, wherein the hardware profile is used to obtain one or more latency hysteresis points, wherein the training of the machine learning model comprises:
acquisition of an initial machine learning model,
updating of features of the initial machine learning model,
updating of dimensions of the initial machine learning model based on the updated features of the machine learning model and the one or more latency hysteresis points, and
generation of a final machine learning model based on the updated dimensions.

12. The system of claim 11, wherein the one or more gates comprise a forget gate unit, an input gate unit, and an output gate unit.

13. The system of claim 11, wherein the one or more gates comprise a gate grid.

14. The system of claim 11, wherein the memory structure further comprises a vector memory storing an input vector configured to provide input values to the one or more gates.

15. The system of claim 11, wherein the memory structure further comprises one or more buffers configured to store output values from the one or more gates.

16. The system of claim 14, wherein the memory structure further comprises an element-wise segmentation module configured to receive stored values from one or more buffers to determine a long-term state vector and a short-term state vector.

17. The system of claim 11, wherein the updating of features of the initial machine learning model further comprises:
a growing of weights in the initial machine learning model using back propagation; and
a pruning of weights of the initial machine learning model.

18. The system of claim 11, wherein the updating of dimensions of the initial machine learning model based on the updated features of the machine learning model and the one or more latency hysteresis points comprises:
a growing of a row or a column of the initial machine learning model based on the one or more latency hysteresis points.

19. The system of claim 11, wherein the updating of dimensions of the initial machine learning model based on the updated features of the machine learning model and the one or more latency hysteresis points comprises:
a pruning of a row or a column of the initial machine learning model based on the one or more latency hysteresis points.

20. The system of claim 11, wherein the hardware profile of the accelerator comprises a model inference latency profile of the accelerator.

21. The system of claim 11, wherein the memory structure is a hidden long-short term memory structure.

22. The system of claim 11, further comprising a host processor configured to determine one or more latency hysteresis points.

23. A device comprising:
a memory configured to store a set of instructions; and
one or more processors configured to execute the set of instructions to cause the device to:
acquire a trained machine learning model based on a hardware profile of the device, wherein the trained machine learning model includes dimensions updated based on one or more latency hysteresis points obtained based on the hardware profile; and
execute the trained machine learning model.

24. The device of claim 23, wherein the dimensions of the trained machine learning model updated based on one or more latency hysteresis point comprises dimensions updated by growing a row or a column of the machine learning model based on the one or more latency hysteresis points.

25. The device of claim 23 any of claims 23 and 21, wherein the dimensions of the trained machine learning model updated based on one or more latency hysteresis point comprises dimensions updated by pruning a row or a column of the machine learning model based on the one or more latency hysteresis points.

26. The device of claim 23, wherein the hardware profile of the device comprises a model inference latency profile of one or more accelerators of the device.

27. The device of claim 23, wherein the one or more processors include an accelerator.
